(19) United States
(12) Patent Application Publication
(10) Pub. No.: US 2025/0083360 A1
(43) Pub. Date: Mar. 13, 2025

(54) METHOD FOR TREATING WASTE PLASTICS BY POLYMER DISSOLUTION AND PURIFICATION BY EXTRACTION

(71) Applicant: IFP Energies nouvelles, Rueil-Malmaison (FR)

(72) Inventors: Damien LEINEKUGEL LE COCQ, RUEIL-MALMAISON CEDEX (FR); Wilfried WEISS, RUEIL-MALMAISON CEDEX (FR); Mathilde SIBEAUD, RUEIL-MALMAISON CEDEX (FR); Frederic AUGIER, RUEIL-MALMAISON CEDEX (FR)

(73) Assignee: IFP Energies nouvelles, Rueil-Malmaison (FR)

(21) Appl. No.: 18/266,930

(22) PCT Filed: Dec. 2, 2021
(86) PCT No.: PCT/EP2021/083869

§ 371 Date: Jun. 13, 2023

(30) Foreign Application Priority Data
Dec. 14, 2020 (FR) FR2013159

(51) Int. Cl. B29B 17/02; B29K 23/00; C08J 11/08

(52) U.S. Cl. CPC B29B 17/02; C08J 11/08; B29B 2017/0217; B29B 2017/0265; B29B 2017/0293; B29K 2023/06; B29K 2023/12

(57) ABSTRACT

A process for treating a plastic feedstock, including a dissolution step involving placing the plastic feedstock in contact with a dissolution solvent, at between 100° C. and 300° C. and pressure of between 1 and 20.0 MPa abs, to dissolve at least a portion of the polymers of the plastic feedstock and to obtain a crude polymer solution. Also, extraction by placing the crude polymer solution in contact with an extraction solvent, at between 100° C. and 300° C., a pressure between 1 and 20.0 MPa abs and at a mass ratio between the mass flow rate of the extraction solvent and the mass flow rate of the crude polymer solution between 0.05 and 20.0, to obtain an extracted polymer solution and a spent solvent. Furthermore, recovering the polymers to obtain a solvent fraction and a purified polymer fraction.

### TECHNICAL FIELD

The present invention relates to a process for treating spent plastics in order to obtain a purified stream of plastics which can be exploited for example as new plastic objects. More particularly, the present invention relates to a process for treating a plastic feedstock, notably obtained from plastic waste, in particular comprising thermoplastics, for instance polyolefins, said process including a step of extracting a polymer solution so as to at least partly remove the impurities, in particular the additives conventionally used in materials based on plastics, for example dyes, pigments, organic and inorganic fillers, so as to be able to upgrade the plastic feedstock, by separating out the polymers, in particular the thermoplastics, which said feedstock contains, to be able to recover them and reuse them.

### PRIOR ART

Plastics obtained from collection and sorting channels can be upgraded according to various channels.

“Mechanical” recycling makes it possible to partly reuse some waste either directly in new objects or by mixing the streams of mechanically sorted plastic waste with streams of virgin polymers. This type of upgrading is limited since mechanical sorting makes it possible to improve the purity of a stream of a given type of polymer but it generally does not make it possible to sufficiently remove the impurities that are at least partly trapped in the polymer matrix, for instance the additives, such as the fillers, dyes, pigments and metals.

“Chemical” recycling is directed towards at least partly reforming monomers via a sequence of steps that is generally complex. For example, plastic waste may undergo a pyrolysis step and the pyrolysis oil recovered, generally after purification, may be at least partly converted, for example, into olefins by steam cracking. These olefins may then be polymerized. This type of sequence may be suitable for feedstocks that have undergone little sorting or for sorting centre refuse but it generally requires a large consumption of energy notably due to the high temperature treatments.

Another route for recycling plastic waste consists in at least partly dissolving the plastics, in particular thermoplastics, for the purpose of purifying them by removing the polymers of the feedstock other than that or those targeted and/or the impurities, for example the additives such as the fillers, dyes, pigments and metals.

Several studies thus present various methods for treating plastic waste by dissolution and purification. US 2017/002110 describes a particular method for purifying a polymer feedstock notably obtained from plastic waste by dissolving the polymer in a solvent, under particular temperature and pressure conditions, followed by placing the polymer solution obtained in contact with a solid.

WO 2018/114047 proposes, for its part, a method for dissolving a plastic in a solvent at a dissolution temperature close to the boiling point of the solvent. However, the process of WO 2018/114047 does not make it possible to efficiently process the impurities other than the polymers.

US 2018/0208736 proposes a treatment process by liquefaction of thermoplastics in a solvent followed by separating out the insoluble matter and/or the gases. The process of US 2018/0208736 does not make it possible to efficiently process the impurities that are soluble in the solvent.

The present invention is directed towards overcoming these drawbacks and participating in the recycling of plastics, in particular thermoplastics. More particularly, it is directed towards proposing a process for treating a plastic feedstock notably obtained from plastic waste, so as to efficiently remove at least part of the impurities, notably the additives conventionally added to plastic materials, and more particularly the impurities that are in particular soluble in organic solvents, so as to be able to upgrade the plastic feedstock and more particularly plastic waste, by separating out and recovering the polymers, in particular the thermoplastics, to be able to use them, for example, as polymeric base for new plastic objects.

### SUMMARY OF THE INVENTION

The invention relates to a process for treating a feedstock, comprising:
a) a dissolution step involving placing the plastic feedstock in contact with a dissolution solvent, at a dissolution temperature of between 100° C. and 300° C. and a dissolution pressure of between 1.0 and 20.0 MPa abs, to obtain at least one crude polymer solution;
b) a step of extraction by placing the crude polymer solution obtained from step a) in contact with an extraction solvent, at a temperature of between 100° C. and 300° C., a pressure of between 1.0 and 20.0 MPa abs and at a mass ratio between the mass flow rate of the extraction solvent and the mass flow rate of the crude polymer solution of between 0.05 and 20.0, to obtain at least one extracted polymer solution and one spent solvent; and then
c) a step of recovering the polymers, to obtain at least one solvent fraction and one purified polymer fraction.

The advantage of the process of the invention is that of proposing a process for the efficient treatment of a feedstock comprising plastics and in particular plastic waste notably obtained from collection and sorting channels, so as to recover the polymers, more particularly the thermoplastics, which it contains to be able to recycle them into any type of application. The process according to the invention indeed makes it possible to obtain a stream of purified polymers, more particularly of purified thermoplastics, and notably of purified polyolefins such as polyethylene and polypropylene, advantageously comprising a content of impurities that is negligible or at least small enough for said stream of purified polymers, more particularly of purified thermoplastics, to be able to be introduced into any plastics formulation in place of virgin polymer resin. For example, the stream of purified polymers, more particularly the stream of purified thermoplastics and notably the stream of purified polyolefins, obtained on conclusion of the process according to the invention advantageously comprises less than 5% by weight of impurities, very advantageously less than 1% by weight of impurities.

The process according to the invention thus proposes a sequence of operations for freeing plastic waste of at least part of its impurities, notably the additives, and for recovering the purified polymers, so as to be able to upgrade the plastic waste by recycling said purified polymers. Advantageously, depending on the conditions used in the steps of the process, the compounds present in the plastic feedstock may be soluble or insoluble in the solvent(s) used throughout the process according to the invention, allowing efficient purification of the polymers.

The invention has the further advantage of participating in the recycling of plastics and in conserving the fossil resources, by enabling the upgrading of plastic waste. Specifically, it allows the purification of plastic waste for the purpose of obtaining purified polymer fractions, with a reduced content of impurities, which are notably decolourized and deodourized, which may be reused for forming new plastic objects. The purified polymer fractions obtained may thus be used directly in formulations as a mixture with additives, for example dyes, pigments or other polymers, in place of or as a mixture with virgin polymer resins, for the purpose of obtaining plastic products having aesthetic, mechanical or rheological working properties which facilitate their reuse and their upgrading.

The present invention also makes it possible to recover the solvent(s) used for treating the plastic feedstock of the process and to recycle them after purification in the process, which avoids excessive consumption of solvent(s).

Thus, the present invention is directed towards purifying a plastic feedstock, in particular plastic waste, to obtain polymers, in particular thermoplastics and more particularly polyolefins such as polyethylene and polypropylene, which are purified so as to be able to use them in any application notably in replacement for virgin polymers. The present invention thus proposes a purification process by dissolving the targeted polymers, i.e. separating them out and purifying them. More particularly, the present invention is directed towards proposing a process comprising a dissolution step followed by at least one specific purification step, more particularly at least one extraction step b), optionally in combination with other intermediate purification steps, to obtain a purified polymer solution from which the purified polymers may be recovered.

### DESCRIPTION OF THE EMBODIMENTS

According to the present invention, the expressions “comprised between . . . and . . . ” and “between . . . and . . . ” are equivalent and mean that the limit values of the interval are included in the described range of values. If such were not the case and if the limit values were not included in the described range, such a clarification will be given by the present invention.

For the purposes of the present invention, the various ranges of parameters for a given step, such as the pressure ranges and the temperature ranges, may be used alone or in combination. For example, for the purposes of the present invention, a range of preferred pressure values can be combined with a range of more preferred temperature values.

In the text hereinbelow, particular embodiments of the invention may be described. They may be implemented separately or combined together without limitation of combination when this is technically feasible.

According to the present invention, the pressures are absolute pressures and are given in MPa absolute (or MPa abs).

The terms “upstream” and “downstream” should be understood as a function of the general flow of the fluid(s) or stream(s) under consideration in the process.

The term “additives” is a term conventionally used in the field of polymers and in particular in the field of polymer formulations. The additives introduced into the polymer formulations may be, for example, plasticizers, fillers (which are organic or mineral solid compounds used for modifying the physical, thermal, mechanical and/or electrical properties of polymer materials or for reducing the cost price thereof), reinforcing agents, dyes, pigments, hardeners, flame retardants, combustion retardants, stabilizers, antioxidants, UV absorbers, antistatic agents, etc.

The additives correspond to a portion of the impurities of the plastic feedstock to be treated and which the treatment process according to the invention makes it possible to at least partly remove. Other types of impurities may be use-related impurities or plastic materials, for instance metal impurities, papers/cardboard, biomass, other polymers, for example of thermosetting or thermoplastic type, etc.

Thus, according to the invention, the impurities which the process according to the invention makes it possible to at least partly remove from the stream of targeted polymers comprise the additives conventionally used in polymer formulations and generally use-related impurities derived from the life cycle of the plastic objects and materials, and/or derived from the waste collection and sorting circuit. Said impurities may be impurities of metallic, organic or mineral type; they may be packaging residues, food residues or compostable residues (biomass). These use-related impurities may also comprise glass, wood, cardboard, paper, aluminium, iron, metals, tyres, rubber, silicones, rigid polymers, thermosetting polymers, household, chemical or cosmetic products, spent oils and water.

According to the invention, a polymer solution is a solution comprising the dissolution solvent and at least polymers, preferably the targeted polymers, more particularly the targeted thermoplastics, notably the targeted polyolefins, dissolved in said dissolution solvent, the dissolved polymers being initially present in the feedstock. The polymer solution may also comprise soluble and/or insoluble impurities. As a function of the steps of the process according to the invention that have been undergone, said polymer solution may comprise impurities in the form of insoluble particles which are advantageously in suspension in said polymer solution, soluble impurities dissolved in the dissolution solvent, and/or optionally another liquid phase that is immiscible with said polymer solution.

The critical temperature and the critical pressure of a solvent, in particular a dissolution solvent and/or an extraction solvent, are intrinsic to said solvent and are, respectively, the temperature and pressure of the critical point of the solvent. As is well known to those skilled in the art, at and above the critical point, the solvent is in supercritical form or in the supercritical state, the temperature and pressure operating conditions being supercritical conditions of the solvent; it may then be referred to as a supercritical fluid.

The invention relates to a process for preparing a plastic feedstock, preferably composed of plastic waste and advantageously comprising polymers, preferably thermoplastics and more particularly polyolefins, said process comprising, and preferably consisting of:
a) a dissolution step involving placing the feedstock in contact with a solvent to obtain at least one crude polymer solution; and then
E1) optionally a step of separating out the insoluble matter to obtain at least one clarified polymer solution and one insoluble fraction;
E2) optionally a washing step, by contact with a dense solution, to obtain at least one washing effluent and one washed polymer solution;
b) an extraction step, by contact with an extraction solvent, to obtain at least one extracted polymer solution and one spent solvent, in particular charged with impurities;
E3) optionally a step of adsorption of the impurities by contact with an adsorbent solid to obtain at least one refined polymer solution; and finally
c) a step of recovering the polymers, to obtain at least one solvent fraction and one purified polymer fraction.

### The feedstock

The feedstock of the process according to the invention, known as the plastic feedstock, comprises plastics which themselves more particularly comprise polymers. Preferably, the plastic feedstock comprises between 50% and 100% by weight and preferably between 70% and 100% by weight of plastics.

The plastics included in the feedstock of the process according to the invention are generally production rejects and/or waste, notably household waste, building waste or electrical and electronic equipment waste. Preferably, the plastic waste is derived from collection and sorting channels. Plastics or plastic materials are generally polymers which are usually mixed with additives, for the purpose of constituting, after forming into shape, various materials and objects (injection-moulded parts, tubes, films, fibres, fabrics, mastics, coatings, etc.). The additives used in plastics may be organic compounds or inorganic compounds. They are, for example, fillers, dyes, pigments, plasticizers, property modifiers, combustion retardants, etc.

The feedstock of the process according to the invention thus comprises polymers and in particular thermoplastics. The polymers included in the plastic feedstock may be alkene polymers, diene polymers, vinyl polymers and/or styrene polymers. Preferably, the polymers included in the plastic feedstock are polyolefins, such as polyethylene (PE), polypropylene (PP) and/or copolymers of ethylene and of propylene. Very preferably, the polymers of the plastic feedstock comprise at least 80% by weight, preferably at least 85% by weight, preferably at least 90% by weight and very preferably at least 94% by weight of polyolefins relative to the total weight of the feedstock. The process according to the invention is thus most particularly directed towards purifying and recovering the polyolefins contained in the feedstock to be able to reuse them in various applications.

The plastic feedstock may comprise mixtures of polymers, in particular mixtures of thermoplastics and/or mixtures of thermoplastics and other polymers, and impurities, notably the additives advantageously used to formulate the plastic material and generally use-related impurities originating from the life cycle of the materials and plastic objects, and/or originating from the waste collection and sorting circuit. The feedstock of the process according to the invention generally comprises less than 50% by weight of impurities, preferably less than 20% by weight of impurities, preferably less than 10% by weight of impurities.

Said feedstock comprising plastics may advantageously be pretreated prior to the process so as to at least remove all or some of the “coarse” impurities, i.e. impurities in the form of particles greater than or equal to 10 mm, preferably greater than or equal to 5 mm, or even greater than or equal to 1 mm in size, for example impurities such as wood, paper, biomass, iron, aluminium, glass, etc., and to put it into form, generally into the form of divided solids so as to facilitate the treatment in the process. This pretreatment may comprise a milling step, a step of washing at atmospheric pressure and/or a drying step. This pretreatment may be performed at a different site, for example in a waste collection and sorting centre, or at the same site where the treatment process according to the invention is performed. Preferably, this pretreatment makes it possible to reduce the content of impurities to less than 6% by weight. On conclusion of the pretreatment, the feedstock is generally stored in the form of divided solids, for example in the form of ground material or powder, so as to facilitate the handling and transportation into the process.

### Dissolution Step a)

According to the invention, the process comprises a dissolution step a) in which the plastic feedstock is placed in contact with a dissolution solvent at a dissolution temperature of between 100° C. and 300° C. and a dissolution pressure of between 1.0 and 20.0 MPa absolute, to obtain at least one, preferably one, crude polymer solution. Specifically, this step advantageously enables the dissolution of at least a portion and preferably of all of the polymers, preferably of the thermoplastics, most particularly of the polyolefins, such as polyethylene and/or polypropylene.

The term “dissolution” should be understood as meaning any phenomenon leading to the production of at least one polymer solution, i.e. a liquid comprising polymers dissolved in a solvent, more particularly in the dissolution solvent. A person skilled in the art is fully aware of the phenomena involved in the dissolution of polymers and which comprises at least mixing, dispersion, homogenization and disentangling of the polymer chains and more particularly of the thermoplastic chains.

In the course of and on conclusion of the dissolution step a), the pressure and temperature conditions make it possible to maintain the dissolution solvent, at least a portion and preferably all of the dissolution solvent, in liquid form, whereas the soluble fraction of the feedstock, in particular the targeted polymers, preferably the targeted thermoplastics and preferably the targeted polyolefins, and at least a portion of the impurities, is advantageously at least partly and preferably totally dissolved.

The placing in contact between the dissolution solvent and the plastic feedstock to at least partly and preferably totally dissolve the polymers of the plastic feedstock in the dissolution solvent may be performed in a line and/or an item of equipment and/or between two items of equipment. Thus, step a) advantageously involves at least one item of dissolution equipment, and optionally at least one feedstock preparation device, a mixing device and/or a transportation device. These items of equipment and/or devices may be, for example, a static mixer, an extruder, a pump, a reactor, a co-current or counter-current column, or in a combination of lines and of equipment. Devices for transportation in particular of fluids, such as gases, liquids or solids, are well known to those skilled in the art. In a nonlimiting manner, the transportation devices may comprise a compressor, a pump, an extruder, a vibrating tube, an endless screw or a valve. The items of equipment and/or devices may also comprise or be combined with heating systems (for example an oven, an exchanger, a tracing, etc.) to achieve the conditions required for dissolution.

The dissolution step a) is at least fed with the plastic feedstock, in particular in the form of one or more streams of plastic feedstock, and with the dissolution solvent, in particular in the form of one or more streams of dissolution solvent, advantageously by means of one or more transportation devices. The stream(s) of plastic feedstock may be different from the stream(s) of dissolution solvent. A portion or all of the plastic feedstock may also feed step a) as a mixture with a portion or all of the dissolution solvent, the remainder of the solvent and/or of the feedstock, where appropriate, possibly feeding step a) separately.

During the placing of the plastic feedstock in contact with the dissolution solvent, the dissolution solvent is advantageously at least partly, and preferably totally, in liquid form, whereas the plastic feedstock, which comprises polymers, in particular thermoplastics and notably polyolefins, may be in solid or liquid form optionally comprising solid particles in suspension. The plastic feedstock may also optionally be injected into the dissolution equipment, as a mixture with the dissolution solvent, in the form of a suspension in the dissolution solvent, the preparation and injection of the suspension possibly being continuous or batchwise.

Preferably, step a) includes at least one extruder and dissolution equipment. In this case, the plastic feedstock feeds the extruder such that, at the extruder outlet, at least a portion and preferably all of the targeted polymers, in particular the targeted thermoplastics, more particularly the polyolefins, included in the feedstock are in molten form. The plastic feedstock is then injected at least partly in molten form into the dissolution equipment. The plastic feedstock, at least partly in molten form, may also be pumped by means of a pump dedicated to viscous fluids, often known as a melt pump or a gear pump. The plastic feedstock at least partly in molten form may, at the extruder outlet, also be filtered using a filtration device, optionally in addition to the melt pump, for the purpose of removing the coarsest particles; generally, the mesh size of this filter is between 10 microns and 1 mm, preferably between 20 and 200 microns.

Preferably, step a) includes an extruder into which the dissolution solvent is injected, advantageously at several points, so as to promote shear and thus intimate mixing between the dissolution solvent and the plastic feedstock, which contributes towards dissolving the polymers, in particular thermoplastics and more particularly polyolefins.

The dissolution solvent used in the dissolution step a) is advantageously an organic solvent or a mixture of solvents that are preferably organic. Preferably, the dissolution solvent is chosen from organic solvents, preferably comprising, and preferentially consisting of, one or more hydrocarbons, with a boiling point of between −50° C. and 250° C., preferably between −15° C. and 150° C., preferably between 20 and 110° C. Preferably, the dissolution solvent comprises, and preferably consists of, one or more hydrocarbons, very preferably one or more alkanes, containing between 3 and 12 carbon atoms, preferentially between 4 and 8 carbon atoms and very preferably between 5 and 7 carbon atoms, for example pentane, hexane and heptane isomers. Preferably, the dissolution solvent, which is very advantageously an organic solvent, preferably a hydrocarbon, has a critical temperature of between 90 and 400° C., preferably between 130 and 300° C. and preferably between 180 and 290° C., and a critical pressure of between 1.5 and 5.0 MPa abs, preferably between 2.0 and 4.3 MPa abs and preferably between 2.4 and 4.2 MPa abs. According to a particular embodiment, the boiling point of the dissolution solvent is greater than 70° C., preferably between 80° C. and 220° C., and/or the solvent comprises, and preferably consists of, an alkane containing at least 7 carbon atoms. According to another preferred embodiment, the boiling point of the dissolution solvent is below 50° C. or above 150° C.

Advantageously, the dissolution is performed at a dissolution temperature of between 100° C. and 300° C., and at a dissolution pressure of between 1.0 and 20.0 MPa absolute. More particularly, the temperature and the pressure evolve throughout step a), from ambient conditions, i.e. a temperature of the plastic feedstock of between 10 and 30° C. and atmospheric pressure of 1 bar (0.1 MPa), until the dissolution conditions are reached, more particularly the dissolution temperature and the dissolution pressure. In particular, the dissolution temperature is between 100 and 300° C., preferably between 150 and 250° C., and the dissolution pressure is between 1.0 and 20.0 MPa abs, preferably between 1.5 and 15.0 abs and very preferably between 2.0 and 10.0 MPa abs. Very advantageously, on conclusion of the dissolution step a), the stream of dissolved polymer is at the dissolution temperature and at the dissolution pressure. Preferably, the weight ratio between the plastic feedstock and the dissolution solvent is between 0.01 and 5.0, preferably between 0.05 and 3.0, preferably between 0.10 and 1.0.

Limiting the temperature in step a), to a temperature of less than or equal to 300° C., preferably less than or equal to 250° C., makes it possible to prevent or to limit the thermal degradation of the polymers, in particular of the thermoplastics and more particularly of the polyolefins. Preferably, the dissolution temperature is greater than or equal to the melting point of the polymers, in particular of the thermoplastics and more particularly of the polyolefins, so as to promote their dissolution. Preferably, the temperature in the dissolution step a) is less than or equal to the critical temperature of the dissolution solvent so as to avoid the formation of a supercritical phase during the dissolution step a) which is liable to disrupt the dissolution.

In parallel, the dissolution pressure is greater than the saturating vapour pressure of the dissolution solvent, at the dissolution temperature, so that the dissolution solvent is at least partly, and preferably totally, in liquid form at the dissolution temperature. Advantageously, the dissolution pressure is greater than or equal to the critical pressure of the dissolution solvent, so as to be able to perform the extraction step b) and/or the recovery step c) under conditions in which at least a portion of the solvent is in supercritical form without it being necessary to considerably increase the pressure between step a), in particular between the outlet of step a), and step b) and/or step c). In the case where the dissolution pressure in step a) is greater than or equal to the critical pressure of the dissolution solvent, the dissolution temperature is less than the critical temperature of the dissolution solvent, so as to keep the dissolution solvent at least partly in liquid form.

Very advantageously, the dissolution temperature and pressure conditions reached in step a) are adjusted so that the mixture (dissolution solvent+targeted polymers) is a one-phase mixture.

Advantageously, said dissolution step a) is performed for a residence time of between 1 and 600 minutes, preferably between 2 and 300 minutes, preferably between 2 and 180 minutes. The residence time is understood as being the residence time at the dissolution temperature and at the dissolution pressure, i.e. the time of implementation of the plastic feedstock with the dissolution solvent at the dissolution temperature and at the dissolution pressure, in step a).

Advantageously, the dissolution solvent used in step a) comprises, and preferably consists of, a supply of fresh solvent and/or a stream of recycled solvent obtained from the recovery step c). Optionally, the treatment process may include an intermediate adsorption step a′), situated during the dissolution step a) or directly downstream of the dissolution step a), and which comprises the introduction of adsorbent solid, preferably such as alumina, silica, silica-alumina, active charcoal or decolourizing earth, in the form of divided particles, into the crude polymer solution obtained on conclusion of step a) or optionally during the dissolution step a). The adsorbent solid may then be removed during one of the optional intermediate purification steps, for example during an optional step E1) of separation of the insoluble matter and/or an optional washing step E2). This optional step a′) of adsorption in the presence of adsorbent solid in divided form makes it possible to optimize the purification of the polymer solution.

The crude polymer solution obtained on conclusion of the dissolution step a) comprises at least the dissolution solvent, polymers, in particular the targeted polymers that the invention seeks to recover purified, dissolved in the dissolution solvent. In general, the crude polymer solution also comprises soluble impurities that are also dissolved in the dissolution solvent and/or insoluble impurities or compounds in suspension. The crude polymer solution obtained on conclusion of step a) may optionally also comprise polymers, other than the polymers targeted, for example in molten form.

### Optional Step E1) of Separating Out the Insoluble Matter

The treatment process may optionally also comprise an optional step E1) of separating out the insoluble matter by solid-liquid separation, situated between the dissolution step a) and the extraction step b), to advantageously obtain at least one clarified polymer solution and one insoluble fraction. The insoluble fraction advantageously comprises at least a portion, and preferably all, of the insoluble impurities, notably in suspension in the crude polymer solution obtained from step a).

Step E1) of separating out the insoluble matter thus makes it possible to remove at least a portion, and preferably all, of the particles of insoluble compounds in the dissolution solvent under the temperature and pressure conditions of step a), which may be present in suspension in the polymer solution, preferably the crude polymer solution obtained from step a) or from an optional step a′). The insoluble impurities removed during the optional step E1) of separating out the insoluble matter are, for example, pigments, mineral compounds, packaging residues (glass, wood, cardboard, paper, aluminium) and insoluble polymers.

When it is performed, this separation step E1) advantageously makes it possible to limit the operating problems, in particular such as clogging and/or erosion, of the downstream process steps, while at the same time contributing towards the purification of the plastic feedstock. When it is incorporated into the process, step E1) of separating out the insoluble matter is advantageously performed at a temperature of between 100 and 300° C., preferably between 150 and 250° C., and at a pressure of between 1.0 and 20.0 MPa abs, preferably between 1.5 and 15.0 MPa abs and very preferably between 2.0 and 10.0 MPa absolute. Very advantageously, the optional step E1) of separating out the insoluble matter is performed under the dissolution temperature and pressure conditions, i.e. under the temperature and pressure conditions at the outlet of step a).

When it is incorporated into the process, said step E1) of separating out the insoluble matter is preferably fed with the crude polymer solution obtained from step a) or obtained from an optional intermediate adsorption step a′).

When it is incorporated into the process, said step E1) advantageously includes a section comprising at least one item of solid-liquid separation equipment, for example a separating flask, a decanter, a centrifugal decanter, a centrifuge, a filter, a sand filter, an eddy current separator, an electrostatic separator, a triboelectric separator, preferably a decanter, a filter, a sand filter and/or an electrostatic separator.

The removal of the insoluble fraction may be facilitated by equipment for transporting and/or removing the traces of solvent that may be present in the insoluble fraction, for example a conveyor, a vibrating tube, an endless screw, an extruder or a stripper. The optional step E1) may thus include equipment for transporting and/or removing traces of solvent to remove the insoluble fraction.

According to a particular embodiment of the optional step E1), step E1) of separating out the insoluble matter includes at least two, and generally less than five, items of solid-liquid separation equipment in series and/or in parallel. The presence of at least two items of solid-liquid separation equipment in series makes it possible to improve the removal of the insoluble matter, whereas the presence of equipment in parallel makes it possible to manage the maintenance of said equipment and/or of the unclogging operations.

The unclogging of equipment, notably of electrostatic separators or filters, may be performed using a backflush-injected solvent. The unclogging solvent may be an aqueous or organic solution, preferably an organic solvent of identical nature to that used in the dissolution step a) and/or the extraction step b). According to a particular embodiment, the unclogging solvent is of identical nature to the dense solution used in the optional washing step E2). Some insoluble compounds, notably some pigments and mineral fillers, conventionally added during the formulation of polymers, may be introduced in the form of particles less than 1 μm in size. This is the case, for example, for titanium dioxide, calcium carbonate and carbon black. According to a particular embodiment of the optional step E1), said step E1) of separating out the insoluble matter advantageously includes an electrostatic separator, which makes it possible to efficiently remove at least a portion, preferably all, of the insoluble particles less than 1 μm in size. According to another particular embodiment of the optional step E1), step E1) of separating out the insoluble matter includes a sand filter, to remove the particles of different sizes and notably the particles less than 1 μm in size.

Depending on the nature of the feedstock, the polymer solution which feeds step E1), preferably the crude polymer solution, may optionally also comprise a second liquid phase, for example consisting of molten polymers. According to another particular embodiment of the optional step E1), step E1) advantageously includes equipment for separating out this second liquid phase, preferably by means of at least one three-phase separator.

### Optional Washing Step E2)

The treatment process may optionally also comprise a step E2) of washing with a dense solution, situated between the dissolution step a) and the extraction step b), to advantageously obtain at least one washing effluent and one washed polymer solution. The washed polymer solution obtained on conclusion of the optional step E2) advantageously comprises the targeted polymers that the present invention seeks to recover purified, dissolved in the dissolution solvent. Optionally, it may still comprise residual impurities which are in particular soluble in the dissolution solvent and/or optionally traces of the washing solvent if step E2) is performed.

When it is incorporated into the process, the washing step E2) is fed with a dense solution and with the polymer solution, preferably the crude polymer solution obtained from step a) or obtained from an optional intermediate adsorption step a′), or else with the clarified polymer solution obtained from the optional step E1). The polymer solution which feeds step E2) may optionally be a refined polymer solution obtained from an optional adsorption step E3), in particular performed by addition of the adsorbent as a mixture with the polymer solution. The polymer solution which feeds the optional washing step E2), i.e. the crude polymer solution, the clarified or else optionally refined polymer solution, may comprise impurities in the form of insoluble compounds in suspension and/or dissolved compounds. These compounds in suspension or dissolved compounds may be partly or totally removed during the washing step E2) by dissolution or precipitation and/or by entrainment in the dense solution. Thus, when it is performed, this step E2) contributes towards the treatment of the plastic feedstock and more particularly towards the purification of the polymer solution.

The optional washing step E2) advantageously involves placing the polymer solution, which feeds step E2) (the crude polymer solution, the clarified or else optionally refined polymer solution), in contact with a dense solution. Advantageously, the dense solution has a higher density than the polymer solution (i.e. the mixture comprising at least the targeted polymers and the dissolution solvent in which the targeted polymers are dissolved), in particular greater than or equal to 0.85, preferably greater than or equal to 0.9, preferentially greater than or equal to 1.0. The dense solution may be an aqueous solution, which preferably comprises at least 50% by weight of water, preferably at least 75% by weight of water, very preferably at least 90% by weight of water. The pH of the aqueous solution may be adjusted using an acid or a base so as to promote the dissolution of some compounds. The dense solution may also optionally be a solution comprising, preferably consisting of, an organic solvent with a density advantageously greater than or equal to 0.85, preferably greater than or equal to 0.9, preferentially greater than or equal to 1.0, and in which the polymers of the plastic feedstock remain insoluble under the temperature and pressure conditions of the optional step E2), for example an organic solvent chosen from sulfolane or N-methylpyrrolidone (NMP), optionally as a mixture with water. Very preferably, the dense solution is an aqueous solution which preferably comprises at least 50% by weight of water, preferably at least 75% by weight of water, very preferably at least 90% by weight of water.

The optional washing step E2) is advantageously performed at a temperature of between 100 and 300° C., preferably between 150 and 250° C., and at a pressure of between 1.0 and 20.0 MPa abs, preferably between 1.5 and 15.0 MPa abs and very preferably between 2.0 and 10.0 MPa abs. Very advantageously, the optional washing step E2) is performed at the dissolution temperature and the dissolution pressure.

In the optional washing step E2), the mass ratio between the mass flow rate of the dense solution and the mass flow rate of the crude or clarified polymer solution feeding step E2) is advantageously between 0.05 and 20.0, preferably between 0.1 and 10.0 and preferably between 0.5 and 3.0. The placing in contact between the crude or clarified polymer solution and the dense solution may be performed at several points in the equipment used, i.e. via several injections of the crude or clarified polymer solution and/or of the dense solution at different points along the equipment; it is then the sum of the streams injected that is taken into account in the calculation of the ratio.

The optional step E2) may be performed in one or more items of washing equipment enabling the placing in contact with the dense solution and/or with separation equipment making it possible to recover at least one washing effluent and one washed polymer solution. This equipment is well known, for example stirred reactors, static mixers, decanting mixers, two-phase or three-phase separating flasks, co-current or counter-current washing columns, plate columns, stirred columns, packed columns, pulsed columns, etc., each type of equipment possibly comprising one or more items of equipment used alone or in combination with equipment of another type.

According to a preferred embodiment, the optional washing step E2) is performed in a counter-current washing column in which the dense solution is injected, preferably into the half, preferably the third, of the column that is the closest to the top of the column, on the one hand, and the crude or clarified polymer solution is injected, preferably into the half, preferably the third, of the column that is the closest to the bottom of the column, on the other hand. According to this embodiment, it is possible to recover at least one washed polymer solution and one washing effluent.

According to a very particular embodiment, the streams at the washing column inlet and/or outlet may be divided and injected at several injection points along the column and/or withdrawn at several withdrawal points along the column.

According to another embodiment, the optional washing step E2) is performed in a mixer-decanter comprising a stirred mixing zone, to place the dense solution and the crude or clarified polymer solution in contact, and a decantation zone, making it possible to recover a washed polymer solution and a washing effluent.

On conclusion of the washing step E2), the washing effluent obtained advantageously comprises compounds dissolved in the dense solvent and/or insoluble compounds entrained in the washing effluent. The washing effluent may be retreated in a washing treatment section, on the one hand to at least partly separate out the dissolved and/or entrained compounds and optionally to purify the washing effluent, to obtain a purified dense solution, and on the other hand to at least partly recycle a portion of the purified washing solution. This washing treatment section may include one or more items of equipment that are well known for solid-liquid separation, for example a separating flask, a decanter, a centrifugal decanter, a centrifuge or a filter. The washing effluent may also be sent outside the process, for example to a spent water treatment station when the dense solution is an aqueous solution.

### Extraction Step b)

The process according to the invention comprises a step b) of extraction, advantageously fed with an extraction solvent and the crude polymer solution obtained from step a) or optionally with the clarified polymer solution obtained from the optional step E1), with the washed polymer solution obtained from the optional step E2) or else a refined solution obtained from an optional adsorption step E3), to obtain at least one extracted polymer solution and one spent solvent in particular charged with impurities. The extracted polymer solution obtained on conclusion of step b) advantageously comprises the targeted polymers that the present invention seeks to recover purified, dissolved in the dissolution solvent. Optionally, it may still comprise residual impurities which are in particular soluble in the dissolution solvent and/or traces of extraction solvent and, if step E2) is performed, optionally traces of the washing solvent.

The stream comprising the dissolved polymers which feeds step b), i.e. preferably the crude polymer solution obtained from step a), the clarified polymer solution obtained from the optional step E1), the washed polymer solution obtained from the optional step E2) or the refined polymer solution obtained from an optional step E3), may thus optionally comprise dissolved compounds or dissolved impurities. These dissolved compounds may be partly or totally removed during the extraction step b) by placing in contact with an extraction solvent.

The extraction step b) advantageously involves at least one extraction section, preferably between one and five extraction sections, very preferably one extraction section. The extraction step b) is performed at a temperature of between 100 and 300° C., preferably between 150 and 250° C. The extraction step b) is performed at a pressure of between 1.0 and 20.0 MPa abs, preferably between 1.5 and 15.0 MPa abs and very preferably between 2.0 and 10.0 MPa abs. According to a preferred embodiment of the invention, the process according to the invention involves an extraction step b) under temperature and pressure conditions different from the temperature and pressure conditions of step a).

The mass ratio between the mass flow rate of the extraction solvent and the mass flow rate of the polymer solution which feeds step b) is advantageously between 0.05 and 20.0, preferably between 0.1 and 10.0 and preferably between 0.2 and 5.0. The placing in contact between the polymer solution which feeds step b), preferably the crude or optionally clarified, washed or refined polymer solution, and the extraction solvent may be performed at several points in the extraction section, i.e. via several injections of the polymer solution which feeds step b) and/or of the extraction solvent at different points along the extraction section; it is then the sum of the streams injected that is taken into account in the calculation of the ratio.

The extraction solvent used in the extraction step b) is advantageously an organic solvent or a mixture of solvents that are preferably organic. Preferably, the extraction solvent is chosen from organic solvents, preferably comprising, and preferentially consisting of, one or more hydrocarbons, with a boiling point of between −50° C. and 250° C., preferably between −15° C. and 150° C., preferably between 20° C. and 110° C. Preferably, the extraction solvent comprises, and preferably consists of, one (or more) hydrocarbons, very preferably one (or more) alkanes, containing between 3 and 12 carbon atoms, preferentially between 4 and 8 carbon atoms and very preferably between 5 and 7 carbon atoms, for example pentane, hexane and heptane isomers. Preferably, the critical temperature of the extraction solvent, which is very advantageously an organic solvent, preferably a hydrocarbon, is between 90 and 400° C., preferably between 130 and 300° C. and preferably between 180 and 290° C., and the critical pressure of the extraction solvent is between 1.5 and 5.0 MPa abs, preferably between 2.0 and 4.3 MPa abs and preferably between 2.4 and 4.2 MPa abs. According to a particular embodiment, the boiling point of the extraction solvent is greater than 70° C., preferably between 80° C. and 220° C., and/or the solvent contains at least 7 carbon atoms. According to another preferred embodiment, the boiling point of the extraction solvent is below 50° C. or above 150° C.

Very preferably, the extraction solvent used in step b) is the same solvent as the dissolution solvent used in step a), optionally in a different physical state (for example the extraction solvent in supercritical form relative to the dissolution solvent in liquid form), so as to facilitate the management of the solvents and notably their purification and their recycling in particular into the dissolution step a) and extraction step b). Another advantage of using identical dissolution and extraction solvents, in identical or different physical states, is, in addition to facilitating the management of the solvents involved in the process according to the invention, in particular the recovery of the solvents, their treatment and their recycling into at least one of the steps of the process, and that of limiting the energy consumptions and the costs generated in particular by the treatment and purification of the solvents.

The extraction section(s) of step b) may comprise one or more items of extraction equipment, enabling the placing in contact with the extraction solvent and/or with separation equipment for recovering at least one spent solvent, in particular charged with impurities, and an extracted polymer solution. This equipment is well known, for instance stirred reactors, static mixers, decanting mixers, two-phase or three-phase separating flasks, co-current or counter-current washing columns, plate columns, stirred columns, packed columns, pulsed columns, etc., each type of equipment possibly comprising one or more items of equipment used alone or in combination with equipment of another type.

According to a preferred embodiment of the invention, the extraction step b) involves a counter-current extraction column where the extraction solvent is injected, on the one hand, and the polymer solution which feeds step b) is injected, on the other hand. According to this embodiment, it is possible to recover at least one extracted polymer solution, on the one hand, and a spent solvent notably charged with impurities, on the other hand. Preferably, the polymer solution which feeds step b), preferably the crude or optionally clarified, washed or refined polymer solution, is injected into the half, preferably the third, of the column that is the closest to the top of the counter-current extraction column, whereas the extraction solvent is injected into the half, preferably the third, of the column that is the closest to the bottom of the counter-current extraction column.

The streams at the counter-current extraction column inlet and/or outlet may be divided at several injection points and/or withdrawal points along the column.

According to another embodiment of the invention, the extraction is performed in a mixer-decanter which advantageously comprises a stirred mixing zone for placing in contact the extraction solvent and the polymer solution, and a decantation zone making it possible to recover an extracted polymer solution, on the one hand, and a spent solvent, on the other hand.

According to a preferred embodiment of the invention, the extraction step b) involves a liquid/liquid extraction section. In this embodiment, the extraction solvent is preferably chosen from pentane, hexane and heptane isomers, preferably from pentane and hexane isomers and very preferably from pentane isomers. Preferably, the liquid/liquid extraction section is operated at between 100° C. and 300° C., preferably between 150° C. and 250° C., and at a pressure of between 1.0 and 20.0 MPa abs, preferably between 1.5 and 15.0 MPa abs and very preferably between 2.0 and 10.0 MPa abs. In any case, in this embodiment, the temperature and pressure conditions are adjusted so that the extraction solvent is in liquid form, the dissolution solvent itself also preferably being in liquid form. Very advantageously, the liquid/liquid extraction, in particular when the extraction solvent is the same as the dissolution solvent, is performed under temperature and pressure conditions that are different from the dissolution conditions achieved in step a), in particular at a temperature above the dissolution temperature and/or at a pressure below the dissolution pressure, so as thus to be in a two-phase zone of the corresponding polymer-solvent mixture diagram.

According to another particularly preferred embodiment of the invention, the extraction step b) includes a section for extraction under particular temperature and pressure conditions in which the extraction solvent is advantageously at least partly in supercritical form. Such an extraction may be referred to as supercritical extraction. In this embodiment, the extraction is performed by placing the polymer solution which feeds step b), preferably the crude, clarified, washed or refined polymer solution, in contact with an extraction solvent, advantageously under temperature and pressure conditions which make it possible to obtain a supercritical phase predominantly (i.e. preferably at least 50% by weight, preferentially at least 70% by weight, preferably at least 90% by weight) composed of the extraction solvent. In other words, the extraction is performed by placing the polymer solution which feeds step b), preferably the crude, clarified, washed or refined polymer solution, in contact with an extraction solvent which is at least partly, preferably totally, in supercritical form. Such a supercritical extraction step b) advantageously allows efficient purification of the polymer solution, notably due to the very high affinity of the organic impurities, for instance some of the additives, notably some dyes, plasticizers, etc., for the supercritical phase. The use of an extraction solvent in supercritical form also makes it possible to create a substantial density difference between the supercritical phase and the polymer solution in liquid form, which facilitates separation by decantation between the supercritical phase and the liquid phase, and this consequently contributes towards the purification of the polymer solution.

In this particularly preferred embodiment, the extraction step b) uses an extraction solvent having a critical temperature preferably between 130 and 300° C. and preferably between 180 and 290° C., and a critical pressure preferably between 2.0 and 4.3 MPa abs and preferably between 2.4 and 4.2 MPa abs. Very advantageously, in such a supercritical extraction step b), the extraction solvent is chosen from hydrocarbons preferentially containing between 4 and 8 carbon atoms, preferably between 5 and 7 carbon atoms. The extraction solvent for the supercritical extraction may be, for example, a pentane isomer, in particular n-pentane, 2-methylbutane (or isopentane) or 2,2-dimethylpropane, a hexane isomer, in particular n-hexane, 2-methylpentane (or isohexane), 2,2-dimethylbutane or 2,3-dimethylbutane, or else a heptane isomer, in particular n-heptane, 2-methylhexane (or isoheptane), 3-methylhexane, 2,2-dimethylpentane, 2,3-dimethylpentane, 2,4-dimethylpentane, 3,3-dimethylpentane, 3-ethylpentane, 2,2,3-trimethylbutane, or cyclopentane, cyclohexane or methylcyclopentane.

Advantageously, the supercritical extraction step b) is performed at a temperature preferably between 150° C. and 300° C., preferably between 180° C. and 280° C., and at a pressure preferably between 2.0 and 20.0 MPa abs, preferably between 2.0 and 15.0 MPa abs and very preferably between 3.0 and 10.0 MPa abs. In any case, in this embodiment, the temperature and pressure conditions are adjusted, notably in an adjustment section included in the extraction step b) upstream of the extraction section, such that the extraction solvent is at least partly in supercritical form in the extraction section.

In a very preferred embodiment of the invention, the extraction step b) involves supercritical extraction and the extraction solvent is the same as the dissolution solvent, apart from the fact that the extraction solvent is at least partly in the supercritical phase. In this very advantageous case of supercritical extraction, the dissolution solvent may become at least partly in supercritical form, advantageously optimizing the decantation during the extraction step, more particularly at each extraction phase or plateau, between the liquid phase and the supercritical phase, which thus makes it possible to maximize the purification.

Advantageously, on conclusion of the extraction step b), the spent solvent obtained is in particular charged with impurities. It may be retreated in an organic treatment section making it possible, on the one hand, to at least partly separate out the impurities and to purify the solvent to obtain a purified extraction solvent, and on the other hand to recycle at least a portion of the purified extraction solvent to the inlet of the extraction step b), and/or optionally to the inlet of the dissolution step a) in the case where the dissolution solvent and the extraction solvent are identical. When a mixture of organic solvents is used as extraction solvent, this organic treatment section may make it possible to at least partly recover the organic solvents separately. The spent solvent may be treated according to any method known to those skilled in the art, for instance one or more methods from among distillation, evaporation, extraction, adsorption, crystallization and precipitation of insoluble matter, or by purging.

In the particular case in which the extraction solvent is the same as the dissolution solvent, the advantage of using an extraction solvent which is identical to the dissolution solvent lies in the fact that the organic treatment section will not need to ensure separation between the dissolution solvent and the extraction solvent, which can both be entrained in the spent solvent, which represents a significant saving in terms of investment and energy consumption. Furthermore, this organic treatment section may be mutualized with a section for treating the solvent fraction recovered on conclusion of step c) and thus reduce at least the investment costs and the energy consumption associated with the treatment of the organic solvent streams arising from the process. Furthermore, limiting, or even reducing to one or two, the number of different solvents used in the process according to the invention makes it possible to simplify the plastic feedstock treatment process, to minimize the consumption of utilities and to optimize the steps of recovery, purification and recycling of the solvents, while at the same time enabling efficient purification of the polymer solution, to obtain purified polymers.

### Optional Adsorption Step E3)

The treatment process may optionally also include an optional adsorption step E3), situated between the dissolution step a) and the polymer recovery step c). Depending on the quality of the starting plastic feedstock and of the impurities it contains, it may in point of fact be advantageous to complete the purification of the polymer solution with an optional adsorption step E3) making it possible to obtain at least one refined polymer solution.

When it is incorporated into the process according to the invention, the adsorption step E3) is performed downstream of the dissolution step a) and upstream of the polymer recovery step c). The optional adsorption step E3) may advantageously be performed upstream or downstream of the extraction step b).

Said optional adsorption step E3) advantageously includes an adsorption section operated in the presence of at least one adsorbent, which is preferably solid, and in particular in the form of a fixed bed, an entrained bed (or slurry, i.e. in the form of particles introduced into the stream to be purified and entrained with this stream) or in the form of an ebullated bed, preferably in the form of a fixed bed or an entrained bed. The adsorption section is advantageously operated in the presence of at least one adsorbent, preferably of alumina, silica, silica-alumina, active charcoal or decolourizing earth type, preferably in the form of a fixed bed or an entrained bed, the circulation of the streams possibly being ascending or descending.

Said optional adsorption step E3) is advantageously performed at a temperature of between 100 and 300° C., preferably between 150 and 250° C., and at a pressure of between 1.0 and 20.0 MPa abs, preferably between 1.5 and 15.0 MPa abs and very preferably between 2.0 and 10.0 MPa abs. Very advantageously, step E3) is performed under the dissolution temperature and pressure conditions, i.e. at the dissolution temperature and the dissolution pressure reached in step a). Preferably, in the optional step E3), the hourly space velocity (or HSV), which corresponds to the ratio between the volume flow rate of the polymer solution which feeds step E3) and the volume of adsorbent, is between 0.05 and 10 h⁻¹, preferentially between 0.1 and 5.0 h⁻¹.

According to a particular embodiment of the optional step E3), the adsorption section may comprise one or more fixed beds of adsorbent, for example in the form of adsorption columns, preferably at least two adsorption columns, preferentially between two and four adsorption columns, containing said adsorbent. When the adsorption section comprises two adsorption columns, one operating mode may be that referred to as “swing” operating according to the dedicated terminology, in which one of the columns is on-line, i.e. in service, while the other column is in reserve. When the adsorbent of the on-line column is spent, this column is isolated, while the column in reserve is brought on-line, i.e. in service. The spent adsorbent can then be regenerated in situ and/or replaced with fresh adsorbent so that the column containing it can once again be brought on-line once the other column has been isolated.

Another mode of functioning of this particular embodiment of step E3), comprising one or more fixed beds of adsorbent, is to have at least two columns functioning in series. When the adsorbent of the column placed at the head is spent, this first column is isolated and the spent adsorbent is either regenerated in situ or replaced with fresh adsorbent. The column is then brought back on-line in the last position, and so on. This operating mode is known as the permutable mode, or as PRS for permutable reactor system or else “lead and lag” according to the dedicated terminology. The combination of at least two adsorption columns makes it possible to overcome the possible and potentially rapid poisoning and/or clogging of the adsorbent due to the combined action of the impurities, of the contaminants and of the insoluble matter that may be present in the stream to be treated. The reason for this is that the presence of at least two adsorption columns facilitates the replacement and/or regeneration of the adsorbent, advantageously without stoppage of the process, also making it possible to control the costs and to limit the consumption of adsorbent.

According to the particular embodiment of the optional step E3) of adsorption in a fixed bed of adsorbent, said optional step E3) is preferably performed downstream of an optional step E1) of separation of the insoluble matter and/or of an optional washing step E2), and upstream or downstream of the extraction step b). Advantageously, the combination of an extraction step b) with an adsorption step E3) allows improved purification of the polymer solution, by using the affinity of the residual impurities both for the extraction solvent and also for the adsorbent solid.

The adsorption section of the optional step E3) may, according to another embodiment, consist in adding adsorbent particles to the polymer solution, in particular the crude polymer solution, said particles possibly being separated from the polymer solution via a step of removing the adsorbent particles located downstream of said adsorption section. In this particular embodiment, the optional adsorption step E3) is advantageously performed before the extraction step b), and in all cases after the dissolution step a). The removal of the adsorbent particles may then advantageously correspond to a step E1) of separating out the insoluble matter or to the washing step E2). Such an implementation of the optional adsorption step E3), by introducing the adsorbent particles followed by solid/liquid separation, advantageously corresponds to the optional intermediate adsorption step a′), described earlier in the present description.

### Step c) of Recovery of the Polymers

According to the invention, the process comprises a step c) of recovering the polymers, to obtain at least one solvent fraction and one purified polymer fraction.

The polymer recovery step c) advantageously includes at least one solvent recovery section, preferably between one and five solvent recovery sections. The polymer recovery step c) is fed with the extracted polymer solution or optionally the refined polymer solution.

The polymer recovery step c) is thus first directed towards at least partly, preferably predominantly, separating out the solvent(s), and in particular the dissolution solvent and optionally the extraction solvent, contained in the polymer solution which feeds step c), i.e. the extracted polymer solution or optionally the refined polymer solution, so as to recover the polymers, at least partly, preferably predominantly and preferentially totally, freed of the dissolution solvent and of the other solvent(s) used in the process that may still be present in the polymer solution which feeds step c). The term “predominantly” should be understood as meaning at least 50% by weight, preferentially preferably at least 70% by weight, preferably at least 90% by weight, very preferably at least 95%, relative to the weight of the solvent(s) contained in the polymer solution which feeds step c), in particular of the dissolution solvent and optionally of the extraction solvent contained in the extracted polymer solution or optionally the refined polymer solution which feeds step c). Any method for separating the solvent from the polymers which is known to those skilled in the art may be performed, notably any method enabling a phase change of the polymers or of the solvent(s). The solvent(s) may be separated out, for example, by evaporation, stripping, demixing, a difference in density and notably decantation or centrifugation, etc.

The purified polymer fraction obtained may correspond to a concentrated polymer solution or to solid purified polymers. Preferably, the polymer recovery step c) also comprises a conditioning section for conditioning the polymers, in solid form and more particularly in the form of solid granules.

The polymer recovery step c) is also directed towards at least partly, preferably predominantly and preferentially totally recovering the solvent(s) contained in the extracted polymer solution or optionally the refined polymer solution which feeds step c), and in particular the dissolution solvent and optionally the extraction solvent. The polymer recovery step c) is also optionally directed towards purifying and recycling the recovered solvent fraction, notably upstream of the dissolution step a) and/or upstream of the extraction step b). The term “predominantly” should be understood as meaning at least 50% by weight, preferentially preferably at least 70% by weight, preferably at least 90% by weight, very preferably at least 95%, relative to the weight of the solvent(s) contained in the extracted polymer solution or optionally the refined polymer solution which feeds step c).

Said polymer recovery step c) advantageously includes at least one solvent recovery section at a temperature of between 0 and 350° C., preferably between 5 and 300° C. and preferably between 10 and 250° C., and at a pressure of between 0.1 and 20.0 MPa abs, preferably between 0.1 and 15.0 MPa abs and very preferably between 0.1 and 10.0 MPa abs.

Advantageously, the polymer recovery step c) includes at least one solvent recovery section, each preferably comprising equipment operated at different temperatures and different pressures, for the purpose of obtaining at least one solvent fraction and one purified polymer fraction. In the case where several different solvents were used in the treatment process according to the invention, in particular in the dissolution step a) and extraction step b), step c) may include several solvent recovery sections, for example two, three or four solvent recovery sections, so as to separately, sequentially and/or successively recover the various solvents, in particular the dissolution solvent and the extraction solvent. Preferably, the dissolution solvent and the extraction solvent are identical and the polymer recovery step c) includes a single solvent recovery section.

According to a particular embodiment of the invention, the process of the present invention includes, advantageously successively or simultaneously:
a solvent recovery section c1) during which the polymer solution is heated preferably to a temperature above the melting point of the polymers, to obtain a solvent fraction and a purified polymer fraction,
a conditioning section c2) during which the purified polymer fraction, advantageously separated from the solvent(s), is cooled, advantageously to a temperature below the melting point of the polymers, to obtain a fraction including polymers in solid form.

According to a preferred embodiment of the invention, step c) includes a section for recovery of the solvent of step c) under temperature and pressure conditions adjusted so as to be under supercritical conditions, i.e. above the critical point, of the solvent(s) to be separated out, in particular of the dissolution solvent, advantageously making it possible to easily separate out and recover at least a portion of the solvent, in particular of the dissolution solvent. In this embodiment, said solvent recovery section in particular includes a system of fluids which is composed of a supercritical phase predominantly comprising solvent, in particular dissolution solvent, and of a liquid phase comprising the polymers. The term “predominantly” means herein at least 50% by weight, preferably at least 70% by weight, preferably at least 90% by weight, very preferably at least 95% by weight, relative to the weight of the stream under consideration, i.e. of the supercritical phase. The separation may then be referred to as supercritical separation of the solvent(s). Supercritical separation of the solvent(s) makes it possible to efficiently separate, on the one hand, the solvent(s) and in particular the dissolution solvent, and, on the other hand, the polymers or optionally a concentrated polymer solution, the supercritical separation advantageously being permitted by the significant difference in density between the two phases. Furthermore, supercritical separation of the solvent(s) advantageously enables a significantly reduced energy and environmental cost relative to simple vaporization of the solvent, since, during passage to the supercritical state, there is no latent heat of vaporization.

According to a particular embodiment of the invention, at least a portion of the purified polymer fraction obtained on conclusion of step c) may be recycled into the dissolution step a), to undergo once again a treatment cycle so as to increase the polymer purification efficiency.

Very advantageously, the solvent fraction recovered on conclusion of step c) may be treated in an organic treatment section located at the end of step c), so as to purify it and to obtain a purified solvent, in particular a purified dissolution solvent, in order advantageously to be able to recycle it into the dissolution step a) and/or optionally into the extraction step b). Said optional organic treatment section at the end of step c) may use any method known to those skilled in the art, for instance one or more methods from among distillation, evaporation, liquid-liquid extraction, adsorption, crystallization and precipitation of insoluble matter, or by purging. In the particular case in which the extraction solvent is the same as the dissolution solvent, the solvent fraction recovered on conclusion of step c) may be treated in the same organic treatment section as the organic treatment section for the spent solvent obtained on conclusion of the extraction step b). The spent solvent obtained in step b) and the solvent fraction obtained in step c) are then treated in the same organic treatment section, which makes it possible to simplify said plastic feedstock treatment process, to minimize the consumption of utilities and to optimize the steps of recovery, purification and recycling of the solvents, while at the same time enabling efficient purification of the polymer solution, to obtain purified polymers.

The process according to the invention thus makes it possible to obtain a purified stream of polymers, in particular of thermoplastics and more particularly of polyolefins, from plastic waste, which may be used in any application, for example in replacement for the same polymers in virgin form. The purified stream of polymers, i.e. the purified polymer fraction, obtained via the process according to the invention thus has an impurity content that is low enough to be able to be used in any application.

According to a preferred embodiment of the invention, the process for treating the plastic feedstock comprises, and preferably consists of:
a step a) of dissolution in a dissolution solvent, to obtain at least one crude polymer solution;
a step E1) of separating out the insoluble matter, fed with the crude polymer solution, to obtain at least one clarified polymer solution and one insoluble fraction;
a step b) of extraction of the clarified polymer solution with an extraction solvent, preferably including a supercritical extraction, to obtain at least one extracted polymer solution and one spent solvent; and
a step c) of recovering the polymers from the extracted polymer solution, preferably including a supercritical separation of the solvent(s), to obtain a solvent fraction and a purified polymer fraction;
   the dissolution solvent and the extraction solvent preferably being identical.

According to another preferred embodiment of the invention, the process for treating the plastic feedstock comprises, and preferably consists of:
a step a) of dissolution in a dissolution solvent, to obtain at least one crude polymer solution;
a step E1) of separating out the insoluble matter, fed with the crude polymer solution, to obtain at least one clarified polymer solution and one insoluble fraction;
a step E2) of washing the clarified polymer solution by contact with a dense solution, to obtain at least one washing effluent and one washed polymer solution;
a step b) of extraction of the washed polymer solution with an extraction solvent, preferably including a supercritical extraction, to obtain at least one extracted polymer solution and one spent solvent; and
a step c) of recovering the polymers from the extracted polymer solution obtained from step b), preferably including a supercritical separation of the solvent(s), to obtain a solvent fraction and a purified polymer fraction;
   the dissolution solvent and the extraction solvent preferably being identical.

According to a particular embodiment of the invention, the process for treating the plastic feedstock comprises, and preferably consists of:
a step a) of dissolution in a dissolution solvent, to obtain at least one crude polymer solution;
a step E2) of washing the crude polymer solution by contact with a dense solution, to obtain at least one washing effluent and one washed polymer solution;
a step E1) of separating out the insoluble matter, fed with the washed polymer solution, to obtain at least one clarified polymer solution and one insoluble fraction;
a step b) of extraction of the clarified polymer solution with an extraction solvent, preferably including a supercritical extraction, to obtain at least one extracted polymer solution and one spent solvent; and
a step c) of recovering the polymers from the extracted polymer solution obtained from step b), preferably including a supercritical separation of the solvent(s), to obtain a solvent fraction and a purified polymer fraction;
   the dissolution solvent and the extraction solvent preferably being identical.

According to another preferred embodiment of the invention, the process for treating the plastic feedstock comprises, and preferably consists of:
a step a) of dissolution in a dissolution solvent, to obtain at least one crude polymer solution;
a step E1) of separating out the insoluble matter, fed with the crude polymer solution, to obtain at least one clarified polymer solution and one insoluble fraction;
a step E2) of washing the clarified polymer solution by contact with a dense solution, to obtain at least one washing effluent and one washed polymer solution;
a step b) of extraction of the washed polymer solution with an extraction solvent, preferably including a supercritical extraction, to obtain at least one extracted polymer solution and one spent solvent;
a step E3) of adsorption by placing the extracted polymer solution in contact with an adsorbent, preferably in a fixed bed, to obtain at least one refined polymer solution; and
a step c) of recovering the polymers from the refined polymer solution obtained from step E3), preferably including a supercritical separation of the solvent(s), to obtain a solvent fraction and a purified polymer fraction;
   the dissolution solvent and the extraction solvent preferably being identical.

According to another preferred alternative embodiment of the invention, the process for treating the plastic feedstock comprises, and preferably consists of:
a step a) of dissolution in a dissolution solvent, to obtain at least one crude polymer solution;
a step E1) of separating out the insoluble matter, fed with the crude polymer solution, to obtain at least one clarified polymer solution and one insoluble fraction;
a step E2) of washing the clarified polymer solution by contact with a dense solution, to obtain at least one washing effluent and one washed polymer solution;
a step E3) of adsorption by placing the washed polymer solution in contact with an adsorbent, preferably in a fixed bed, to obtain at least one refined polymer solution;
a step b) of extraction of the refined polymer solution with an extraction solvent, preferably including a supercritical extraction, to obtain at least one extracted polymer solution and one spent solvent; and
a step c) of recovering the polymers from the extracted polymer solution, preferably including a supercritical separation of the solvent(s), to obtain a solvent fraction and a purified polymer fraction;
   the dissolution solvent and the extraction solvent preferably being identical.

The examples and figures that follow illustrate the invention, in particular particular embodiments of the invention, without limiting the scope thereof.

### LIST OF FIGURES

The information regarding the elements referenced in FIGS. 1 to 3 enables a better understanding of the invention, without said invention being limited to the particular embodiments illustrated in FIGS. 1 to 3. The various embodiments presented may be used alone or in combination with each other, without any limit to the combinations.

FIG. 1 represents the scheme of one embodiment of the process of the present invention, comprising:
a step a) of dissolution of the plastic feedstock 1 comprising polymers in a dissolution solvent 2, to obtain a crude polymer solution 3;
a step b) of extraction of the crude polymer solution 3 with an extraction solvent 9, to obtain an extracted polymer solution 11 and a spent solvent 10;
a step c) of recovering the polymers from the extracted polymer solution 11 obtained from step b), to obtain a solvent fraction 13 and a purified polymer fraction 14.

FIG. 2 is a variant of the implementation of the process according to the invention represented in FIG. 1, comprising:
a step a) of dissolution of the plastic feedstock 1 comprising polymers in a dissolution solvent 2, to obtain a crude polymer solution 3;
a step E1) of separating out the insoluble matter, fed with the crude polymer solution 3, to obtain a clarified polymer solution 5 and an insoluble fraction 4;
a step E2) of washing the clarified polymer solution 5 by contact with a dense solution 6, to obtain a washing effluent 7 and a washed polymer solution 8;
a step b) of extraction of the washed polymer solution 8 with an extraction solvent 9, to obtain an extracted polymer solution 11 and a spent solvent 10;
a step E3) of adsorption by placing the extracted polymer solution 11 in contact with an adsorbent, to obtain a refined polymer solution 12;
a step c) of recovering the polymers from the refined polymer solution 12 obtained from step E3), to obtain a solvent fraction 13 and a purified polymer fraction 14.

FIG. 3 is a variant of the implementation of the process according to the invention represented in FIG. 2. In the embodiment shown in FIG. 3, the process comprises an intermediate step a′) between step a) and step E1). The crude polymer solution 3 is placed in contact with an adsorbent in the form of divided solids for the purpose of obtaining a polymer solution 21 including the adsorbent in suspension and feeding the separation step E1). The adsorbent, introduced beforehand into step a′), is then separated out and removed in the insoluble matter fraction 4.

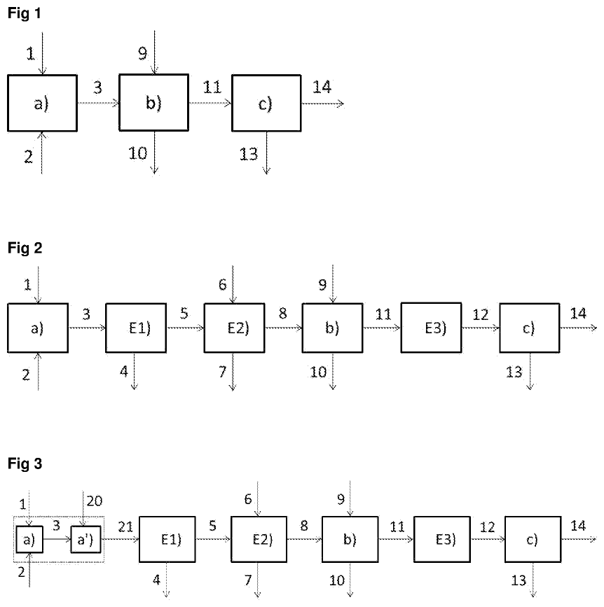

Only the main steps, with the main streams, are shown in FIGS. 1 to 3, so as to allow a better understanding of the invention. It is clearly understood that all the equipment required for the functioning is present (vessels, pumps, exchangers, furnaces, columns, etc.), even if it is not shown.

### EXAMPLES

### Example 1 (in Accordance with the Invention)

125 ml of n-pentane and 23 g of a plastic feedstock in the form of pink-violet-coloured beads 5 mm in diameter and based on polypropylene are introduced into a 500 ml autoclave equipped with a stirrer.

The autoclave is then closed hermetically and heated at 180° C. at a rate of 2° C. per minute, with stirring at 500 revolutions per minute (rpm). Once the temperature of 180° C. has been reached, the temperature and the stirring are maintained for 3 hours, at the autogenous pressure of 2.6 MPa absolute. After 3 hours, all the polypropylene is dissolved in the n-pentane. At the end of the dissolution step, a highly coloured liquid phase, a crude polymer solution, is obtained.

125 mL of n-pentane are then added to the system, and the temperature is increased to 200° C., at a rate of 20° C. per hour, while maintaining the stirring at 500 rpm. The pressure in the autoclave is then increased to 4.0 MPa absolute. At 200° C. and 4.0 MPa absolute, the conditions are supercritical conditions, i.e. above the critical temperature and at the critical pressure of n-pentane. These temperature, pressure and stirring conditions are then maintained for 15 minutes, before stopping the stirring. The system then decants in less than 5 seconds. At the end of the extraction step, two phases are obtained: the lower phase containing the polymer and corresponding to an extracted polymer solution, is then slightly less coloured than the mixture before the extraction step by decantation, and the upper phase has significant colouring.

15 ml of the extracted polymer solution are taken up and placed in a crystallizing dish. The crystallizing dish is then placed in an oven at 180° C. and atmospheric pressure while flushing with nitrogen for 6 hours.

A slightly pinkish white solid is then obtained in the crystallizing dish.

### Example 2 (Not in Accordance with the Invention)

125 ml of n-pentane and 23 g of a plastic feedstock in the form of pink-violet-coloured beads 5 mm in diameter and based on polypropylene are introduced into a 500 ml autoclave equipped with a stirrer.

The autoclave is then closed hermetically and heated at 180° C. at a rate of 2° C. per minute, with stirring at 500 revolutions per minute (rpm). Once the temperature of 180° C. has been reached, the temperature and the stirring are maintained for 3 hours, at the autogenous pressure of 2.6 MPa abs. After 3 hours, all the polypropylene is dissolved in the n-pentane. At the end of the dissolution step, a highly coloured liquid phase, a crude polymer solution, is obtained.

15 ml of the crude polymer solution are taken up and placed in a crystallizing dish. The crystallizing dish is then placed in an oven at 180° C. and atmospheric pressure while flushing with nitrogen for 6 hours.

A pink-violet-coloured solid is thus obtained in the crystallizing dish. The solid obtained has a colour close to that of the beads of the initial feedstock.

1. Process for treating a plastic feedstock, comprising:
a) a dissolution step involving placing the plastic feedstock in contact with a dissolution solvent, at a dissolution temperature of between 100° C. and 300° C. and a dissolution pressure of between 1.0 and 20.0 MPa abs to obtain at least one crude polymer solution;
b) a step of extraction by placing the crude polymer solution obtained from step a) in contact with an extraction solvent, at a temperature of between 100° C. and 300° C., a pressure of between 1.0 and 20.0 MPa abs and at a mass ratio between the mass flow rate of the extraction solvent and the mass flow rate of the crude polymer solution of between 0.05 and 20.0, to obtain at least one extracted polymer solution and one spent solvent; and then
c) a step of recovering the polymers, to obtain at least one solvent fraction and one purified polymer fraction.

2. Process according to claim 1, in which the dissolution solvent is chosen from organic solvents with a boiling point of between −50° C. and 250° C., preferably between −15° C. and 150° C., preferably between 20° C. and 110° C.

3. Process according to claim 1, in which the dissolution solvent has a critical temperature of between 90 and 400° C., preferably between 130 and 300° C. and preferably between 180 and 290° C., and a critical pressure of between 1.5 and 5.0 MPa, preferably between 2.0 and 4.3 MPa and preferably between 2.4 and 4.2 MPa.

4. Process according to claim 1, in which the dissolution temperature in step a) is between 150 and 250° C. and the dissolution pressure is between 1.5 and 15.0 MPa abs and very preferably between 2.0 and 10.0 MPa abs.

5. Process according to claim 1, in which the extraction solvent used in step b) is an organic solvent, preferably a hydrocarbon, which has a critical temperature of between 90 and 400° C., preferably between 130 and 300° C. and preferably between 180 and 290° C., and a critical pressure of between 1.5 and 5.0 MPa abs, preferably between 2.0 and 4.3 MPa abs and preferably between 2.4 and 4.2 MPa abs.

6. Process according to claim 1, in which the extraction solvent is the same as the dissolution solvent, optionally in a different physical state.

7. Process according to claim 1, in which, in step b), the extraction is performed by placing the crude polymer solution obtained from step a) in contact with an extraction solvent which is at least partly, preferably totally, in supercritical form.

8. Process according to claim 7, in which the extraction solvent is a pentane isomer, a hexane isomer or a heptane isomer.

9. Process according to claim 7, in which the extraction step b) is performed at a temperature of between 150° C. and 300° C., preferably between 180° C. and 280° C., and at a pressure preferably between 2.0 and 20.0 MPa abs, preferably between 2.0 and 15.0 MPa abs and very preferably between 3.0 and 10.0 MPa abs.

10. Process according to claim 1, in which the polymer recovery step c) includes a solvent recovery section at a temperature of between 0 and 350° C., preferably between 5 and 300° C. and preferably between 10 and 250° C., and at a pressure of between 0.1 and 20.0 MPa abs, preferably between 0.1 and 15.0 MPa abs and very preferably between 0.1 and 10.0 MPa abs.

11. Process according to claim 1, in which the polymer recovery step c) includes at least one solvent recovery section under temperature and pressure conditions adjusted so as to be under supercritical conditions of the dissolution solvent.

12. Process according to claim 1, comprising a step E1) of separating out the insoluble matter by solid-liquid separation, situated between the dissolution step a) and the extraction step b), and operated at a temperature of between 100° C. and 300° C., a pressure of between 1.0 and 20.0 MPa abs, preferably including an electrostatic separator and/or a filter and/or a sand filter.

13. Process according to claim 1, comprising a step E2) of washing with a dense solution, situated between the dissolution step a) and the extraction step b), and operated at a temperature of between 100° C. and 300° C., a pressure of between 1.0 and 20.0 MPa abs, the dense solution having a density of greater than or equal to 0.85, preferably greater than or equal to 0.9, preferentially greater than or equal to 1.0, the dense solution very preferably being an aqueous solution.

14. Process according to claim 1, comprising an adsorption step E3) situated between the dissolution step a) and the polymer recovery step c) and including an adsorption section operated in the presence of at least one adsorbent, at a temperature of between 100 and 300° C. and a pressure of between 1.0 and 20.0 MPa abs.

15. Process according to claim 1, comprising:
a) a dissolution step involving placing the plastic feedstock in contact with a dissolution solvent, at a dissolution temperature of between 100° C. and 300° C. and a dissolution pressure of between 1.0 and 20.0 MPa abs, to obtain at least one crude polymer solution;
E1) a step of separating out the insoluble matter by solid-liquid separation, at a temperature of between 100° C. and 300° C. and at a pressure of between 1.0 and 20.0 MPa abs, said step E1) being fed with the crude polymer solution obtained from step a), to obtain at least one clarified polymer solution and one insoluble fraction;
b) a step of extraction by placing the clarified polymer solution obtained from step E1) in contact with an extraction solvent, at a temperature of between 100 and 300° C., at a pressure of between 1.0 and 20.0 MPa abs and at a mass ratio between the mass flow rate of the extraction solvent and the mass flow rate of the clarified polymer solution of between 0.05 and 20.0, to obtain at least one extracted polymer solution and one spent solvent; and then
c) a polymer recovery step, to obtain at least one solvent fraction and one purified polymer fraction, said polymer recovery step preferably including at least one solvent recovery section under temperature and pressure conditions adjusted so as to be under supercritical conditions of the dissolution solvent.
